(19) United States
(12) Patent Application Publication
(10) Pub. No.: US 2016/0227517 A1
(43) Pub. Date: Aug. 4, 2016

(54) METHOD FOR SEMI-PERSISTENT SHARED RESOURCE SCHEDULING, AND APPARATUS

(71) Applicant: Huawei Technologies Co., Ltd., Shenzhen (CN)

(72) Inventor: Guanglin Han, Beijing (CN)

(21) Appl. No.: 15/094,105

(22) Filed: Apr. 8, 2016

Related U.S. Application Data
(63) Continuation of application No. PCT/CN2013/084882, filed on Oct. 9, 2013.

(51) Int. Cl. H04W 72/04

(52) U.S. Cl. CPC H04W 72/04

(57) ABSTRACT

Embodiments of the present invention provide a method for semi-persistent shared resource scheduling, and an apparatus. The method includes: sending, by a base station to M user equipments UEs, a configuration enabling message for semi-persistent shared resource scheduling, where M is an integer greater than or equal to two; and periodically scheduling, by the base station, transmission time-frequency resources for the M UEs according to the configuration enabling message for semi-persistent shared resource scheduling, to send data to the M UEs, where the transmission time-frequency resources that the base station schedules to the M UEs each time are a same transmission time-frequency resource.

### CROSS-REFERENCE TO RELATED APPLICATIONS

This application is a continuation of International Application No. PCT/CN2013/084882, filed on Oct. 9, 2013, which is hereby incorporated by reference in its entirety.

### TECHNICAL FIELD

Embodiments of the present invention relate to the field of communications technologies, and in particular, to a method for semi-persistent shared resource scheduling, and an apparatus.

### BACKGROUND

In a Long Term Evolution (Long Term Evolution, LTE for short) system, user data is scheduled in a manner of resource sharing, and a wireless communication resource can be used to a great extent. However, this scheduling manner results in relatively large overheads. Meanwhile, a voice service in a circuit switched domain is canceled in the LTE system and is replaced by a VoIP service in a data domain, but there is usually a larger quantity of voice service users. When shared resource scheduling is performed in the LTE system, related control information is required for transmission each time, which results in excessively large control information overheads, and limits a quantity of users that can be simultaneously supported in the LTE system.

In the prior art, when user equipment (User Equipment, UE for short) uses the VoIP service, and a time interval at which a data packet of this service arrives meets a particular periodic rule, semi-persistent scheduling (Semi-Persistent Scheduling, SPS for short) may be performed in the LTE system. That is, in an LTE scheduling transmission process, during initial scheduling, an evolved NodeB (Evolved NodeB, eNB for short) indicates current scheduling information to each UE by using a physical downlink control channel (Physical Downlink Control Channel, PDCCH for short); the UE saves the current scheduling information when recognizing that the scheduling is SPS, and sends or receives, at a same time-frequency resource location, data of the service at intervals of a fixed period. In this way, PDCCH resource overheads for scheduling indication in the LTE system can be effectively reduced, and more users can be supported.

However, when multiple UEs receive same data sent by an eNB, the eNB still needs to send UE-specific scheduling information to each UE respectively, which results in a waste of wireless communication network resources.

### SUMMARY

Embodiments of the present invention provide a method for semi-persistent shared resource scheduling, and an apparatus, which are used to enable a base station to send data to different UEs by using a same transmission time-frequency resource, to reduce wireless communication network resource overheads.

According to a first aspect, an embodiment of the present invention provides a method for semi-persistent shared resource scheduling, including:

sending, by a base station to M user equipments UEs, a configuration enabling message for semi-persistent shared resource scheduling, where M is an integer greater than or equal to two; and

periodically scheduling, by the base station, transmission time-frequency resources for the M UEs according to the configuration enabling message for semi-persistent shared resource scheduling, to send data to the M UEs, where

the transmission time-frequency resources that the base station schedules to the M UEs each time are a same transmission time-frequency resource.

In a first possible implementation manner of the first aspect, before the sending, by a base station to M user equipments UEs, a configuration enabling message for semi-persistent shared resource scheduling, the method further includes:

determining, by the base station, that the M UEs need to receive same data, or use a same bearer, or use a same service, and determining to periodically schedule a transmission time-frequency resource for the same data, or for data transmission on the same bearer, or for the same service.

With reference to the first aspect or the first possible implementation manner of the first aspect, in a second possible implementation manner of the first aspect, the sending, by a base station to M user equipments UEs, a configuration enabling message for semi-persistent shared resource scheduling includes:

separately sending, by the base station to the M UEs, a configuration enabling message for semi-persistent shared resource scheduling that includes configuration information for semi-persistent shared resource scheduling, so that the M UEs acquire and activate the configuration information for semi-persistent shared resource scheduling.

With reference to the first aspect or the first possible implementation manner of the first aspect, in a third possible implementation manner of the first aspect, the sending, by a base station to M user equipments UEs, a configuration enabling message for semi-persistent shared resource scheduling includes:

separately sending, by the base station to the M UEs, a configuration enabling message for semi-persistent shared resource scheduling that includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling, so that the M UEs acquire and activate the configuration information for semi-persistent shared resource scheduling.

With reference to the first aspect or the first possible implementation manner of the first aspect, in a fourth possible implementation manner of the first aspect, the sending, by a base station to M user equipments UEs, a configuration enabling message for semi-persistent shared resource scheduling includes:

separately sending, by the base station to the M UEs, a configuration allocation message for semi-persistent shared resource scheduling, where the configuration allocation message for semi-persistent shared resource scheduling includes the configuration information for semi-persistent shared resource scheduling; and

sending, by the base station to each of the M UEs, a configuration activation message for semi-persistent shared resource scheduling, where the configuration activation message for semi-persistent shared resource scheduling includes configuration activation instruction information for semi-persistent shared resource scheduling, and the configuration activation instruction information for semi-persistent shared resource scheduling is used to instruct to activate the configuration information for semi-persistent shared resource scheduling.

With reference to the fourth possible implementation manner of the first aspect, in a fifth possible implementation manner of the first aspect, the sending, by the base station to each of the M UEs, a configuration activation message for semi-persistent shared resource scheduling includes:

sending, by the base station to the M UEs respectively, configuration activation messages for semi-persistent shared resource scheduling, so that each UE of the M UEs separately activates the configuration information for semi-persistent shared resource scheduling.

With reference to the fifth possible implementation manner of the first aspect, in a sixth possible implementation manner of the first aspect, the sending, by the base station to the M UEs respectively, configuration activation messages for semi-persistent shared resource scheduling includes:

sending, by the base station to each UE, a configuration activation message for semi-persistent shared resource scheduling that is scrambled by using a shared scheduling cell radio network temporary identifier C-RNTI of each UE, where the shared scheduling C-RNTIs of the UEs are different shared scheduling C-RNTIs.

With reference to the fourth possible implementation manner of the first aspect, in a seventh possible implementation manner of the first aspect, the sending, by the base station to each of the M UEs, a configuration activation message for semi-persistent shared resource scheduling includes:

sending, by the base station to the MUEs, a same configuration activation message for semi-persistent shared resource scheduling, so that the M UEs simultaneously activate the configuration information for semi-persistent shared resource scheduling.

With reference to the seventh possible implementation manner of the first aspect, in an eighth possible implementation manner of the first aspect, the sending, by the base station to the M UEs, a same configuration activation message for semi-persistent shared resource scheduling includes:

sending, by the base station to each UE, a same configuration activation message for semi-persistent shared resource scheduling that is scrambled by using the first shared scheduling C-RNTI, where a shared scheduling C-RNTI of each UE is the first shared scheduling C-RNTI.

With reference to the third possible implementation manner of the first aspect, the fourth possible implementation manner of the first aspect, the fifth possible implementation manner of the first aspect, the sixth possible implementation manner of the first aspect, the seventh possible implementation manner of the first aspect, or the eighth possible implementation manner of the first aspect, in a ninth possible implementation manner of the first aspect, the configuration activation instruction information for semi-persistent shared resource scheduling that is sent to each UE by the base station includes at least one of the following: an activation instruction for instructing the UE to activate the semi-persistent shared scheduling configuration information, information indicating a transmission frequency-domain resource that is scheduled to each UE by the base station, and information indicating a shared scheduling feedback channel time-frequency resource of each UE.

With reference to the ninth possible implementation manner of the first aspect, in a tenth possible implementation manner of the first aspect, the configuration information for semi-persistent shared resource scheduling that is sent to each UE by the base station includes at least one of the following: the shared scheduling C-RNTI of each UE, a scheduling interval at which the base station schedules a transmission time-frequency resource for each UE, a quantity of data transmission processes, and a set of shared scheduling feedback channel time-frequency resource information of each UE.

With reference to the tenth possible implementation manner of the first aspect, in an eleventh possible implementation manner of the first aspect, the configuration information for semi-persistent shared resource scheduling further includes shared scheduling reference signal configuration information.

With reference to the ninth possible implementation manner of the first aspect or the tenth possible implementation manner of the first aspect, in a twelfth possible implementation manner of the first aspect, the method further includes:

sending, by the base station, the shared scheduling reference signal configuration information to the M UEs by means of system broadcast.

With reference to the ninth possible implementation manner of the first aspect, the tenth possible implementation manner of the first aspect, the eleventh possible implementation manner of the first aspect, or the twelfth possible implementation manner of the first aspect, in a thirteenth possible implementation manner of the first aspect, the periodically scheduling, by the base station, transmission time-frequency resources for the M UEs according to the configuration enabling message for semi-persistent shared resource scheduling, to send data to the M UEs includes:

determining, by the base station according to the information indicating the transmission frequency-domain resources that are scheduled to the M UEs, and times at which the base station sends the configuration activation instruction information for semi-persistent shared resource scheduling to the M UEs, the transmission time-frequency resources periodically scheduled to the M UEs; and

sending, on the transmission time-frequency resources by the base station, the data to the M UEs.

With reference to the thirteenth possible implementation manner of the first aspect, in a fourteenth possible implementation manner of the first aspect, the data includes control information and first data, the first data is data that needs to be transmitted, the control information includes identification information of at least one of the UEs and length information of the first data, and the control information is used to instruct the at least one UE to acquire the first data according to the data length information.

According to a second aspect, an embodiment of the present invention provides a method for semi-persistent shared resource scheduling, including:

receiving, by user equipment UE, a configuration enabling message for semi-persistent shared resource scheduling sent by a base station; and

periodically receiving, by the UE according to the configuration enabling message for semi-persistent shared resource scheduling, data sent on a transmission time-frequency resource that is scheduled to the UE by the base station, where

the transmission time-frequency resource scheduled to the UE by the base station each time and transmission time-frequency resources scheduled by the base station to M UEs including the UE are a same transmission time-frequency resource, and M is an integer greater than or equal to two.

In a first possible implementation manner of the second aspect, the receiving, by user equipment UE, a configuration enabling message for semi-persistent shared resource scheduling sent by a base station includes:

receiving, by the UE, a configuration enabling message for semi-persistent shared resource scheduling that is sent by the base station and that includes configuration information for semi-persistent shared resource scheduling; and

acquiring and activating, by the UE according to the configuration enabling message for semi-persistent shared resource scheduling, the configuration information for semi-persistent shared resource scheduling.

In a second possible implementation manner of the second aspect, the receiving, by user equipment UE, a configuration enabling message for semi-persistent shared resource scheduling sent by a base station includes:

receiving, by the UE, a configuration enabling message for semi-persistent shared resource scheduling that is sent by the base station and that includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling; and

acquiring and activating, by the UE according to the configuration information for semi-persistent shared resource scheduling and the configuration activation instruction information for semi-persistent shared resource scheduling, the configuration information for semi-persistent shared resource scheduling.

In a third possible implementation manner of the second aspect, the receiving, by user equipment UE, a configuration enabling message for semi-persistent shared resource scheduling sent by a base station includes:

receiving, by the UE, a configuration allocation message for semi-persistent shared resource scheduling sent by the base station, where the configuration allocation message for semi-persistent shared resource scheduling includes the configuration information for semi-persistent shared resource scheduling;

acquiring, by the UE, the configuration information for semi-persistent shared resource scheduling;

receiving, by the UE, a configuration activation message for semi-persistent shared resource scheduling sent by the base station; and

activating, by the UE according to the acquired configuration information for semi-persistent shared resource scheduling and the configuration activation instruction information for semi-persistent shared resource scheduling, the configuration information for semi-persistent shared resource scheduling.

With reference to the third possible implementation manner of the second aspect, in a fourth possible implementation manner of the second aspect, the receiving, by the UE, a configuration activation message for semi-persistent shared resource scheduling sent by the base station includes:

receiving, by the UE, a configuration activation message for semi-persistent shared resource scheduling that is sent by the base station and that is scrambled by using a shared scheduling cell radio network temporary identifier C-RNTI of the UE.

With reference to the second possible implementation manner of the second aspect, the third possible implementation manner of the second aspect, or the fourth possible implementation manner of the second aspect, in a fifth possible implementation manner of the second aspect, the configuration activation instruction information for semi-persistent shared resource scheduling includes at least one of the following: an activation instruction for instructing the UE to activate the semi-persistent shared scheduling configuration information, information indicating a transmission frequency-domain resource that is scheduled to the UE by the base station, and information indicating a shared scheduling feedback channel time-frequency resource of the UE.

With reference to the fifth possible implementation manner of the second aspect, in a sixth possible implementation manner of the second aspect, the configuration information for semi-persistent shared resource scheduling includes at least one of the following: the shared scheduling C-RNTI of the UE, a scheduling interval at which the base station schedules a transmission time-frequency resource for the UE, a quantity of data transmission processes, and a set of shared scheduling feedback channel time-frequency resource information of the UE.

With reference to the sixth possible implementation manner of the second aspect, in a seventh possible implementation manner of the second aspect, the configuration information for semi-persistent shared resource scheduling further includes shared scheduling reference signal configuration information.

With reference to the fifth possible implementation manner of the second aspect or the sixth possible implementation manner of the second aspect, in an eighth possible implementation manner of the second aspect, the method further includes:

receiving, by the UE, shared scheduling reference signal configuration information that is sent by the base station by means of system broadcast.

With reference to the fifth possible implementation manner of the second aspect, the sixth possible implementation manner of the second aspect, the seventh possible implementation manner of the second aspect, or the eighth possible implementation manner of the second aspect, in a ninth possible implementation manner of the second aspect, the periodically receiving, by the UE according to the configuration enabling message for semi-persistent shared resource scheduling, data sent on a transmission time-frequency resource that is scheduled to the UE by the base station includes:

determining, by the UE according to the information indicating the transmission frequency-domain resource that is scheduled to the UE by the base station, and a time at which the UE receives the configuration activation instruction information for semi-persistent shared resource scheduling, the transmission time-frequency resource periodically scheduled to the UE by the base station; and

receiving, on the transmission time-frequency resource by the UE, the data sent by the base station.

With reference to the ninth possible implementation manner of the second aspect, in a tenth possible implementation manner of the second aspect, the data includes control information and first data, the first data is data that needs to be transmitted, the control information includes identification information of the UE and length information of the first data, and the control information is used to instruct the UE to acquire the first data according to the data length information; and

the receiving, on the transmission time-frequency resource by the UE, the data sent by the base station includes:
acquiring, by the UE, the first data according to the control information.

According to a third aspect, an embodiment of the present invention provides a base station, including:

a sending unit, configured to send, to M user equipments UEs, a configuration enabling message for semi-persistent shared resource scheduling, where M is an integer greater than or equal to two; and

a processing unit, configured to periodically schedule transmission time-frequency resources for the M UEs according to the configuration enabling message for semi-persistent shared resource scheduling, to send data to the M UEs, where

the transmission time-frequency resources that the base station schedules to the M UEs each time are a same transmission time-frequency resource.

In a first possible implementation manner of the third aspect, the base station further includes:

a determining unit, configured to: before the sending unit sends, to the M user equipments UEs, the configuration enabling message for semi-persistent shared resource scheduling, determine that the M UEs need to receive same data, or use a same bearer, or use a same service, and determine to periodically schedule a transmission time-frequency resource for the same data, or for data transmission on the same bearer, or for the same service.

With reference to the third aspect or the first possible implementation manner of the third aspect, in a second possible implementation manner of the third aspect, the sending unit is specifically configured to separately send, to the M UEs, a configuration enabling message for semi-persistent shared resource scheduling that includes configuration information for semi-persistent shared resource scheduling, so that the M UEs acquire and activate the configuration information for semi-persistent shared resource scheduling.

With reference to the third aspect or the first possible implementation manner of the third aspect, in a third possible implementation manner of the third aspect, the sending unit is specifically configured to separately send, to the M UEs, a configuration enabling message for semi-persistent shared resource scheduling that includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling, so that the M UEs acquire and activate the configuration information for semi-persistent shared resource scheduling.

With reference to the third aspect or the first possible implementation manner of the third aspect, in a fourth possible implementation manner of the third aspect, the sending unit is specifically configured to separately send, to the M UEs, a configuration allocation message for semi-persistent shared resource scheduling, where the configuration allocation message for semi-persistent shared resource scheduling includes configuration information for semi-persistent shared resource scheduling; and send, to each of the M UEs, a configuration activation message for semi-persistent shared resource scheduling, where the configuration activation message for semi-persistent shared resource scheduling includes configuration activation instruction information for semi-persistent shared resource scheduling, and the configuration activation instruction information for semi-persistent shared resource scheduling is used to instruct to activate the configuration information for semi-persistent shared resource scheduling.

With reference to the fourth possible implementation manner of the third aspect, in a fifth possible implementation manner of the third aspect, the sending unit is specifically configured to send, to the M UEs respectively, configuration activation messages for semi-persistent shared resource scheduling, so that each UE of the M UEs separately activates the configuration information for semi-persistent shared resource scheduling.

With reference to the fifth possible implementation manner of the third aspect, in a sixth possible implementation manner of the third aspect, the sending unit is specifically configured to send, to each UE, a configuration activation message for semi-persistent shared resource scheduling that is scrambled by using a shared scheduling cell radio network temporary identifier C-RNTI of each UE, where the shared scheduling C-RNTIs of the UEs are different shared scheduling C-RNTIs.

With reference to the fourth possible implementation manner of the third aspect, in a seventh possible implementation manner of the third aspect, the sending unit is specifically configured to send, to the M UEs, a same configuration activation message for semi-persistent shared resource scheduling, so that the M UEs simultaneously activate the configuration information for semi-persistent shared resource scheduling.

With reference to the seventh possible implementation manner of the third aspect, in an eighth possible implementation manner of the third aspect, the sending unit is specifically configured to send, to each UE, a same configuration activation message for semi-persistent shared resource scheduling that is scrambled by using the first shared scheduling C-RNTI, where a shared scheduling C-RNTI of each UE is the first shared scheduling C-RNTI.

With reference to the third possible implementation manner of the third aspect, the fourth possible implementation manner of the third aspect, the fifth possible implementation manner of the third aspect, the sixth possible implementation manner of the third aspect, the seventh possible implementation manner of the third aspect, or the eighth possible implementation manner of the third aspect, in a ninth possible implementation manner of the third aspect, the configuration activation instruction information for semi-persistent shared resource scheduling that is sent to each UE by the sending unit includes at least one of the following: an activation instruction for instructing the UE to activate the semi-persistent shared scheduling configuration information, information indicating a transmission frequency-domain resource that is scheduled to each UE by the base station, and information indicating a shared scheduling feedback channel time-frequency resource of each UE.

With reference to the ninth possible implementation manner of the third aspect, in a tenth possible implementation manner of the third aspect, the configuration information for semi-persistent shared resource scheduling that is sent to each UE by the sending unit includes at least one of the following: the shared scheduling C-RNTI of each UE, a scheduling interval at which the base station schedules a transmission time-frequency resource for each UE, a quantity of data transmission processes, and a set of shared scheduling feedback channel time-frequency resource information of each UE.

With reference to the tenth possible implementation manner of the third aspect, in an eleventh possible implementation manner of the third aspect, the configuration information for semi-persistent shared resource scheduling further includes shared scheduling reference signal configuration information.

With reference to the ninth possible implementation manner of the third aspect or the tenth possible implementation manner of the third aspect, in a twelfth possible implementation manner of the third aspect, the sending unit is further configured to send the shared scheduling reference signal configuration information to the M UEs by means of system broadcast.

With reference to the ninth possible implementation manner of the third aspect, the tenth possible implementation manner of the third aspect, the eleventh possible implementation manner of the third aspect, or the twelfth possible implementation manner of the third aspect, in a thirteenth possible implementation manner of the third aspect, the processing unit includes:

a determining subunit, configured to determine, according to the information indicating the transmission frequency-domain resources that are scheduled to the M UEs, and times at which the base station sends the configuration activation instruction information for semi-persistent shared resource scheduling to the M UEs, the transmission time-frequency resources periodically scheduled to the M UEs; and

a sending subunit, configured to send, on the transmission time-frequency resources, the data to the M UEs.

With reference to the thirteenth possible implementation manner of the third aspect, in a fourteenth possible implementation manner of the third aspect, the data includes control information and first data, the first data is data that needs to be transmitted, the control information includes identification information of at least one of the UEs and length information of the first data, and the control information is used to instruct the at least one UE to acquire the first data according to the data length information.

According to a fourth aspect, an embodiment of the present invention provides user equipment UE, including:

a receiving unit, configured to receive a configuration enabling message for semi-persistent shared resource scheduling sent by a base station; and

a processing unit, configured to periodically receive, according to the configuration enabling message for semi-persistent shared resource scheduling, data sent on a transmission time-frequency resource that is scheduled to the UE by the base station, where

the transmission time-frequency resource scheduled to the UE by the base station each time and transmission time-frequency resources scheduled by the base station to M UEs including the UE are a same transmission time-frequency resource, and M is an integer greater than or equal to two.

In a first possible implementation manner of the fourth aspect, the receiving unit is specifically configured to receive a configuration enabling message for semi-persistent shared resource scheduling that is sent by the base station and that includes configuration information for semi-persistent shared resource scheduling; and acquire and activate, according to the configuration enabling message for semi-persistent shared resource scheduling, the configuration information for semi-persistent shared resource scheduling.

In a second possible implementation manner of the fourth aspect, the receiving unit is specifically configured to receive a configuration enabling message for semi-persistent shared resource scheduling that is sent by the base station and that includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling; and acquire and activate, according to the configuration information for semi-persistent shared resource scheduling and the configuration activation instruction information for semi-persistent shared resource scheduling, the configuration information for semi-persistent shared resource scheduling.

In a third possible implementation manner of the fourth aspect, the receiving unit is specifically configured to receive a configuration allocation message for semi-persistent shared resource scheduling sent by the base station, where the configuration allocation message for semi-persistent shared resource scheduling includes the configuration information for semi-persistent shared resource scheduling; acquire the configuration information for semi-persistent shared resource scheduling; receive a configuration activation message for semi-persistent shared resource scheduling sent by the base station; and activate, according to the acquired configuration information for semi-persistent shared resource scheduling and the configuration activation instruction information for semi-persistent shared resource scheduling, the configuration information for semi-persistent shared resource scheduling.

With reference to the third possible implementation manner of the fourth aspect, in a fourth possible implementation manner of the fourth aspect, the receiving unit is specifically configured to receive a configuration activation message for semi-persistent shared resource scheduling that is sent by the base station and that is scrambled by using a shared scheduling cell radio network temporary identifier C-RNTI of the UE.

With reference to the second possible implementation manner of the fourth aspect, the third possible implementation manner of the fourth aspect, or the fourth possible implementation manner of the fourth aspect, in a fifth possible implementation manner of the fourth aspect, the configuration activation instruction information for semi-persistent shared resource scheduling includes at least one of the following: an activation instruction for instructing the UE to activate the semi-persistent shared scheduling configuration information, information indicating a transmission frequency-domain resource that is scheduled to the UE by the base station, and information indicating a shared scheduling feedback channel time-frequency resource of the UE.

With reference to the fifth possible implementation manner of the fourth aspect, in a sixth possible implementation manner of the fourth aspect, the configuration information for semi-persistent shared resource scheduling includes at least one of the following: the shared scheduling C-RNTI of the UE, a scheduling interval at which the base station schedules a transmission time-frequency resource for the UE, a quantity of data transmission processes, and a set of shared scheduling feedback channel time-frequency resource information of the UE.

With reference to the sixth possible implementation manner of the fourth aspect, in a seventh possible implementation manner of the fourth aspect, the configuration information for semi-persistent shared resource scheduling further includes shared scheduling reference signal configuration information.

With reference to the fifth possible implementation manner of the fourth aspect or the sixth possible implementation manner of the fourth aspect, in an eighth possible implementation manner of the fourth aspect, the receiving unit is further configured to receive shared scheduling reference signal configuration information that is sent by the base station by means of system broadcast.

With reference to the fifth possible implementation manner of the fourth aspect, the sixth possible implementation manner of the fourth aspect, the seventh possible implementation manner of the fourth aspect, or the eighth possible implementation manner of the fourth aspect, in a ninth possible implementation manner of the fourth aspect, the processing unit includes:

a determining subunit, configured to determine, according to the information indicating the transmission frequency-domain resource that is scheduled to the UE by the base station, and a time at which the UE receives the configuration activation instruction information for semi-persistent shared resource scheduling, the transmission time-frequency resource periodically scheduled to the UE by the base station; and

a receiving subunit, configured to receive, on the transmission time-frequency resource, the data sent by the base station.

With reference to the ninth possible implementation manner of the fourth aspect, in a tenth possible implementation manner of the fourth aspect, the data includes control information and first data, the first data is data that needs to be transmitted, the control information includes identification information of the UE and length information of the first data, and the control information is used to instruct the UE to acquire the first data according to the data length information; and

the receiving subunit is specifically configured to acquire the first data according to the control information.

In the method for semi-persistent shared resource scheduling, and the apparatus provided in the embodiments of the present invention, a base station sends, to M UEs, a configuration enabling message for semi-persistent shared resource scheduling, and periodically schedules transmission time-frequency resources for the M UEs according to the configuration enabling message for semi-persistent shared resource scheduling, to send data to the M UEs, where the transmission time-frequency resources that the base station schedules to the M UEs each time are a same transmission time-frequency resource. Because the base station sends data to different UEs by using a same transmission time-frequency resource, wireless communication network resource overheads can be reduced.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a method for semi-persistent shared resource scheduling according to the present invention;

FIG. 2 is a flowchart of Embodiment 2 of a method for semi-persistent shared resource scheduling according to the present invention;

FIG. 3 is a flowchart of Embodiment 3 of a method for semi-persistent shared resource scheduling according to the present invention;

FIG. 4 is a schematic diagram of data in the embodiment of the method for semi-persistent shared resource scheduling shown in FIG. 3;

FIG. 5 is a flowchart of Embodiment 4 of a method for semi-persistent shared resource scheduling according to the present invention;

FIG. 6 is a schematic diagram of a set of shared scheduling feedback channel time-frequency resource information in the embodiment of the method for semi-persistent shared resource scheduling shown in FIG. 5;

FIG. 7 is a flowchart of Embodiment 5 of a method for semi-persistent shared resource scheduling according to the present invention;

FIG. 8 is a schematic structural diagram of Embodiment 1 of a base station according to the present invention;

FIG. 9 is a schematic structural diagram of Embodiment 2 of a base station according to the present invention;

FIG. 10 is a schematic structural diagram of Embodiment 1 of UE according to the present invention; and

FIG. 11 is a schematic structural diagram of Embodiment 2 of UE according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

FIG. 1 is a flowchart of Embodiment 1 of a method for semi-persistent shared resource scheduling according to the present invention. As shown in FIG. 1, the method in this embodiment may include:

S101. Abase station sends, to M UEs, a configuration enabling message for semi-persistent shared resource scheduling.

In this embodiment, the base station may send, to the M UEs, a configuration enabling message for semi-persistent shared resource scheduling, where M is an integer greater than or equal to two, so that the M UEs acquire, according to the configuration enabling message for semi-persistent shared resource scheduling, configuration information for semi-persistent shared resource scheduling, and enable the configuration information for semi-persistent shared resource scheduling, and then, the M UEs may acquire, according to the configuration information for semi-persistent shared resource scheduling, data sent by the base station.

S102. The base station periodically schedules transmission time-frequency resources for the M UEs according to the configuration enabling message for semi-persistent shared resource scheduling, to send data to the M UEs.

In this embodiment, after sending, to the M UEs, the configuration enabling message for semi-persistent shared resource scheduling, the base station periodically schedules transmission time-frequency resources for the M UEs according to the configuration enabling message for semi-persistent shared resource scheduling, to send data to the M UEs, that is, the base station periodically schedules a transmission time-frequency resource for each UE according to the configuration enabling message for semi-persistent shared resource scheduling, to send data to the UE, where scheduling periods for all the UEs are the same. The transmission time-frequency resources that the base station schedules to the M UEs each time are a same transmission time-frequency resource, that is, the base station periodically schedules a same transmission time-frequency resource according to the configuration enabling message for semi-persistent shared resource scheduling, to send data to the M UEs, and all the M UEs can acquire, from the same transmission time-frequency resource during each scheduling, the data sent by the base station. In this way, the base station may not need to schedule a UE-specific time-frequency resource for each UE to send data to the UE, thereby reducing wireless communication network resource overheads.

In the method for semi-persistent shared resource scheduling provided in Embodiment 1 of the present invention, a base station sends, to M UEs, a configuration enabling message for semi-persistent shared resource scheduling, and periodically schedules transmission time-frequency resources for the M UEs according to the configuration enabling message for semi-persistent shared resource scheduling, to send data to the M UEs, where the transmission time-frequency resources that the base station schedules to the M UEs each time are a same transmission time-frequency resource. Because the base station sends data to different UEs by using a same transmission time-frequency resource, wireless communication network resource overheads can be reduced.

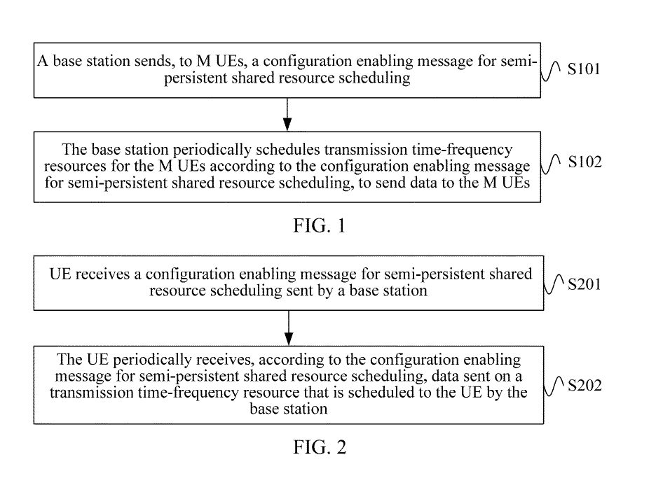

FIG. 2 is a flowchart of Embodiment 2 of a method for semi-persistent shared resource scheduling according to the present invention. As shown in FIG. 2, the method in this embodiment may include:

S201. UE receives a configuration enabling message for semi-persistent shared resource scheduling sent by a base station.

S202. The UE periodically receives, according to the configuration enabling message for semi-persistent shared resource scheduling, data sent on a transmission time-frequency resource that is scheduled to the UE by the base station.

In this embodiment, the UE receives a configuration enabling message for semi-persistent shared resource scheduling sent by the base station, acquires configuration information for semi-persistent shared resource scheduling, enables the configuration information for semi-persistent shared resource scheduling, and then, periodically receives, according to the enabled configuration information for semi-persistent shared resource scheduling, data sent on a transmission time-frequency resource that is scheduled to the UE by the base station. The transmission time-frequency resource scheduled to the UE by the base station each time and transmission time-frequency resources scheduled by the base station to M UEs including the UE are a same transmission time-frequency resource, where M is an integer greater than or equal to two, that is, the transmission time-frequency resource scheduled to the UE by the base station and transmission time-frequency resources scheduled by the base station to other UEs of the M UEs are a same transmission time-frequency resource, that is, transmission time-frequency resources scheduled by the base station to the M UEs are a same transmission time-frequency resource.

In the method for semi-persistent shared resource scheduling provided in Embodiment 2 of the present invention, UE receives a configuration enabling message for semi-persistent shared resource scheduling sent by a base station, and periodically receives, according to the configuration enabling message for semi-persistent shared resource scheduling, data sent on a transmission time-frequency resource that is scheduled to the UE by the base station, where the transmission time-frequency resource scheduled to the UE by the base station each time and transmission time-frequency resources scheduled by the base station to M UEs including the UE are a same transmission time-frequency resource. Because the base station sends data to different UEs by using a same transmission time-frequency resource, wireless communication network resource overheads can be reduced.

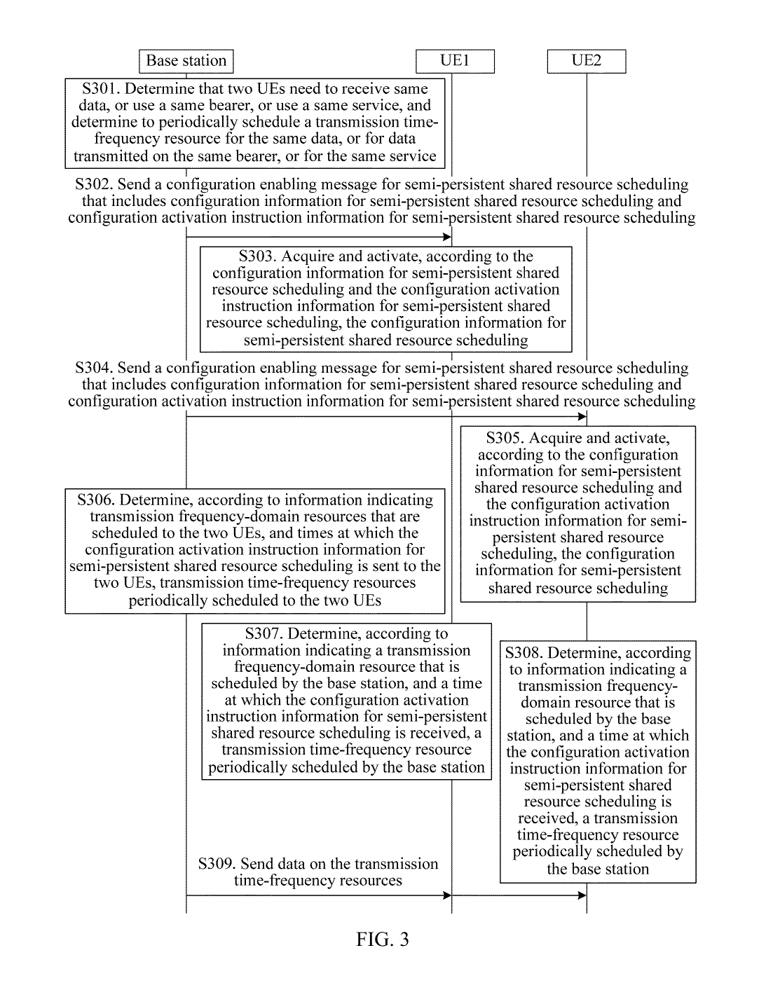

FIG. 3 is a flowchart of Embodiment 3 of a method for semi-persistent shared resource scheduling according to the present invention. As shown in FIG. 3, the method in this embodiment may include:

S301. Determine that two UEs need to receive same data, or use a same bearer, or use a same service, and determine to periodically schedule a transmission time-frequency resource for the same data, or for data transmission on the same bearer, or for the same service.

In this embodiment, a base station may determine that M UEs need to receive same data, and the base station determines that a transmission time-frequency resource may be periodically scheduled for the same data received by the M UEs; or the base station may determine that M UEs use a same bearer, and the base station determines that a transmission time-frequency resource may be periodically scheduled for data transmission on the same bearer; or the base station may determine that M UEs use a same service, and the base station determines that a transmission time-frequency resource may be periodically scheduled for the same service. In this case, the base station may perform semi-persistent shared resource scheduling for the M UEs, where M is an integer greater than or equal to two. In this embodiment, that M is two is used as an example for description, and in this case, the M UEs include UE1 and UE2.

In this embodiment, by determining that synchronization numbers of data sent to the M UEs are the same, the base station may determine that the M UEs are going to receive same data; by determining that the M UEs use a same physical channel, a same transmission channel, and a same logical channel, the base station may determine that the M UEs use a same bearer; by determining that service identifiers and/or session identifiers that correspond to service data received by the M UEs are the same, the base station may determining that the M UEs use a same service and receive same service data.

S302. Send a configuration enabling message for semi-persistent shared resource scheduling that includes configuration information for semi-persistent shared resource scheduling and configuration activation instruction information for semi-persistent shared resource scheduling.

S303. Acquire and activate, according to the configuration information for semi-persistent shared resource scheduling and the configuration activation instruction information for semi-persistent shared resource scheduling, the configuration information for semi-persistent shared resource scheduling.

S304. Send a configuration enabling message for semi-persistent shared resource scheduling that includes configuration information for semi-persistent shared resource scheduling and configuration activation instruction information for semi-persistent shared resource scheduling.

S305. Acquire and activate, according to the configuration information for semi-persistent shared resource scheduling and the configuration activation instruction information for semi-persistent shared resource scheduling, the configuration information for semi-persistent shared resource scheduling.

In this embodiment, the base station may separately send, to the two UEs, a configuration enabling message for semi-persistent shared resource scheduling that includes configuration information for semi-persistent shared resource scheduling and configuration activation instruction information for semi-persistent shared resource scheduling. That is, a configuration enabling message for semi-persistent shared resource scheduling includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling, so that the two UEs acquire and activate the configuration information for semi-persistent shared resource scheduling. That is, the base station may separately send, to the UE1 and the UE2, a configuration enabling message for semi-persistent shared resource scheduling that includes configuration information for semi-persistent shared resource scheduling and configuration activation instruction information for semi-persistent shared resource scheduling. It should be noted that a feedback channel time-frequency resource indicated in the configuration enabling message, sent by the base station to the UE1, for semi-persistent shared resource scheduling may be different from a feedback channel time-frequency resource indicated in the configuration enabling message, sent by the base station to the UE2, for semi-persistent shared resource scheduling. Then, the UE1 and the UE2 may separately receive the configuration enabling message for semi-persistent shared resource scheduling that is sent by the base station and that includes the configuration information for semi-persistent shared resource scheduling and the configuration activation instruction information for semi-persistent shared resource scheduling. It should be noted that the base station may separately send, to the UE1 and the UE2 at a same time, the configuration enabling message for semi-persistent shared resource scheduling that includes the configuration information for semi-persistent shared resource scheduling and the configuration activation instruction information for semi-persistent shared resource scheduling. That is, S302 and S304 are simultaneously performed. The base station may also send the configuration information for semi-persistent shared resource scheduling in the configuration enabling message for semi-persistent shared resource scheduling, and implicitly send the configuration activation instruction information for semi-persistent shared resource scheduling. After the UE receives the message, the UE acquires and activates the configuration information for semi-persistent shared resource scheduling.

Optionally, the configuration activation instruction information for semi-persistent shared resource scheduling that is sent to each UE of the two UEs by the base station includes at least one of the following: an activation instruction for instructing the UE to activate the semi-persistent shared scheduling configuration information, information indicating a transmission frequency-domain resource that is scheduled to each UE by the base station, and information indicating a shared scheduling feedback channel time-frequency resource of each UE. Information indicating transmission frequency-domain resources that are scheduled to the two UEs by the base station may include a resource number indicator of a physical resource block or a resource number indicator of a physical resource group, and the transmission frequency-domain resources scheduled to the two UEs by the base station are the same. The information indicating a shared scheduling feedback channel time-frequency resource of each UE may be an indicator that indicates a physical uplink control channel (Physical Uplink Control Channel, PUCCH for short) resource location used by each UE and that is in the configuration information for semi-persistent shared resource scheduling. That is, the configuration activation instruction information for semi-persistent shared resource scheduling that is sent to the UE1 by the base station includes information indicating a transmission frequency-domain resource that is scheduled to the UE1 by the base station, and information indicating a time-frequency resource for shared scheduling feedback information of the UE1; and the configuration activation instruction information for semi-persistent shared resource scheduling that is sent to the UE2 by the base station includes information indicating a transmission frequency-domain resource that is scheduled to the UE2 by the base station, and information indicating a time-frequency resource for shared scheduling feedback information of the UE2. It should be noted that locations of shared scheduling feedback channel time-frequency resources of the UE1 and the UE2 are different.

Optionally, the configuration information for semi-persistent shared resource scheduling that is sent to each UE by the base station includes at least one of the following: a shared scheduling cell radio network temporary identifier (Cell Radio Network Temporary Identifier, C-RNTI for short) of the UE, a scheduling interval at which the base station schedules a transmission time-frequency resource for the UE, a quantity of data transmission processes, and a set of shared scheduling feedback channel time-frequency resource information of the UE. The base station may schedule a transmission time-frequency resource for each UE at a same interval, and the set of shared scheduling feedback channel time-frequency resource information of each UE may be a list that indicates PUCCH feedback channel resources of each UE. For example, the configuration information for semi-persistent shared resource scheduling that is sent to the UE1 by the base station includes at least one of the following: a shared scheduling C-RNTI of the UE1, a scheduling interval at which the base station schedules a transmission time-frequency resource for the UE1, a quantity of data transmission processes, and a set of shared scheduling feedback channel time-frequency resource information of the UE1. The configuration information for semi-persistent shared resource scheduling that is sent to the UE2 by the base station includes at least one of the following: a shared scheduling C-RNTI of the UE2, a scheduling interval at which the base station schedules a transmission time-frequency resource for the UE2, a quantity of data transmission processes, and a set of shared scheduling feedback channel time-frequency resource information of the UE2.

Optionally, the configuration information for semi-persistent shared resource scheduling that is sent to each UE by the base station may further include shared scheduling reference signal configuration information, where the shared scheduling reference signal configuration information may be a reference signal configuration or a reference signal configuration set that corresponds to each UE and that is to be used for decoding in semi-persistent shared resource scheduling.

Optionally, this embodiment may further include: sending, by the base station, shared scheduling reference signal configuration information to the two UEs by means of system broadcast. For example, the base station sends shared scheduling reference signal configuration information to the UE1 and the UE2 by means of system broadcast, and correspondingly, the UE1 and the UE2 receive the shared scheduling reference signal configuration information that is sent by the base station by means of system broadcast.

In this embodiment, the UE1 receives the configuration enabling message for semi-persistent shared resource scheduling, and the UE1 may acquire and activate, according to the configuration information for semi-persistent shared resource scheduling and the configuration activation instruction information for semi-persistent shared resource scheduling that are in the configuration enabling message for semi-persistent shared resource scheduling, the configuration information for semi-persistent shared resource scheduling. The UE2 receives the configuration enabling message for semi-persistent shared resource scheduling, and the UE2 may acquire and activate, according to the configuration information for semi-persistent shared resource scheduling and the configuration activation instruction information for semi-persistent shared resource scheduling that are in the configuration enabling message for semi-persistent shared resource scheduling, the configuration information for semi-persistent shared resource scheduling.

S306. Determine, according to information indicating transmission frequency-domain resources that are scheduled to the two UEs, and times at which the configuration activation instruction information for semi-persistent shared resource scheduling is sent to the two UEs, transmission time-frequency resources periodically scheduled to the two UEs.

In this embodiment, the base station determines, according to information indicating transmission frequency-domain resources that are scheduled to the two UEs, and times at which the base station sends the configuration activation instruction information for semi-persistent shared resource scheduling to the two UEs, transmission time-frequency resources periodically scheduled to the two UEs, where the transmission time-frequency resources that the base station schedules to the two UEs each time are a same transmission time-frequency resource. That is, the base station may determine a transmission time-frequency resource according to the information indicating transmission frequency-domain resources that are scheduled to the UE1 and the UE2, and the times at which the base station sends the configuration activation instruction information for semi-persistent shared resource scheduling to the UE1 and the UE2, where the transmission time-frequency resource is a transmission time-frequency resource scheduled to the UE1 and the UE2, so that the transmission time-frequency resources scheduled to the UE1 and the UE2 are a same transmission time-frequency resource. It should be noted that the information indicating the transmission frequency-domain resource that is scheduled to the UE1 by the base station is the same as the information indicating the transmission frequency-domain resource that is scheduled to the UE2 by the base station, and the time at which the base station sends the configuration activation instruction information for semi-persistent shared resource scheduling to the UE1 is also the same as the time at which the base station sends the configuration activation instruction information for semi-persistent shared resource scheduling to the UE2.

Specifically, an implementation process of determining, by the base station, transmission time-frequency resources periodically scheduled to the UE1 and the UE2 is shown as follows: The base station may determine, according to the times at which the base station sends the configuration activation instruction information for semi-persistent shared resource scheduling to the UE1 and the UE2, and the following formula, the transmission time-frequency resources scheduled to the UE1 and the UE2 by the base station:

(10*SFN+subframe)=[(10*SFNₛₜₐᵣₜₜᵢₘₑₛ+subframeₛₜₐᵣₜₜᵢₘₑ)+N*semiP ersistent SchedIntervalDL]modulo10240, where modulo indicates a modulo remainder, semiPersistent SchedIntervalDL indicates a scheduling interval at which the base station schedules the transmission time-frequency resource for the UE1 and the UE2, SFNₛₜₐᵣₜₜᵢₘₑₛ indicates a system frame number that corresponds to the time at which the base station sends the configuration activation instruction information for semi-persistent shared resource scheduling to the UE1 and the UE2, subframeₛₜₐᵣₜₜᵢₘₑ indicates a subframe number that corresponds to a time at which the base station sends the configuration activation instruction information for semi-persistent shared resource scheduling to the UE1 and the UE2, N indicates that it is the N^{th} semi-persistent shared resource scheduling performed by the base station for the UE1 and the UE2, SFN indicates a number of a system frame in a transmission time-frequency resource that the base station schedules to the UE1 and the UE2 the N^{th} time, and subframe indicates a numbers of a subframe in the transmission time-frequency resource that the base station schedules to the UE1 and the UE2 the N^{th} time.

The base station may determine, according to the information indicating the transmission frequency-domain resources that are scheduled to the UE1 and the UE2, the transmission frequency-domain resources scheduled to the UE1 and the UE2, and may determine, according to the transmission frequency-domain resources scheduled to the UE1 and the UE2 and transmission time domain resources scheduled to the UE1 and the UE2, the transmission time-frequency resources scheduled to the UE1 and the UE2.

S307. Determine, according to information indicating a transmission frequency-domain resource that is scheduled by the base station, and a time at which the configuration activation instruction information for semi-persistent shared resource scheduling is received, a transmission time-frequency resource periodically scheduled by the base station.

S308. Determine, according to information indicating a transmission frequency-domain resource that is scheduled by the base station, and a time at which the configuration activation instruction information for semi-persistent shared resource scheduling is received, a transmission time-frequency resource periodically scheduled by the base station.

In this embodiment, the UE1 may determine, according to information indicating a transmission frequency-domain resource that is scheduled by the base station to the UE1, and a time at which the UE1 receives the configuration activation instruction information for semi-persistent shared resource scheduling, a transmission time-frequency resource periodically scheduled to the UE1 by the base station. Specifically, an implementation process of determining, by the UE1, a transmission time-frequency resource periodically scheduled to the UE1 by the base station is described below. The UE1 may determine, according to the time at which the UE1 receives the configuration activation instruction information for semi-persistent shared resource scheduling sent by the base station, and the following formula, the transmission time-frequency resource scheduled to the UE1 by the base station:

(10*SFN′+subframe′)=[(10*SFN_{start times}′+subframe_{start time}′)+N*semiPersistent SchedIntervalDL]modulo10240, where modulo indicates a modulo remainder, semiPersistent SchedIntervalDL indicates a scheduling interval at which the base station schedules a transmission time-frequency resource for the UE1, SFN_{start times}′ indicates a system frame number that corresponds to the time at which the UE1 receives the configuration activation instruction information for semi-persistent shared resource scheduling sent by the base station, subframe_{start time}′ indicates a subframe number that corresponds to the time at which the UE1 receives the configuration activation instruction information for semi-persistent shared resource scheduling sent by the base station, N indicates that it is the N^{th} semi-persistent shared resource scheduling performed by the base station for the UE1, SFN′ indicates a number of a system frame in a transmission time-frequency resource that the base station schedules to the UE1 the N^{th} time, and subframe′ indicates a number of a subframe in the transmission time-frequency resource that the base station schedules to the UE1 the N^{th} time.

The UE1 may determine, according to the information indicating the transmission frequency-domain resource that is scheduled to the UE1 by the base station, the transmission frequency-domain resource scheduled to the UE1, and may determine, according to the transmission frequency-domain resource scheduled to the UE1 and a transmission time domain resource scheduled to the UE1, the transmission time-frequency resource scheduled to the UE1 by the base station. A specific implementation process for the UE2 is similar to the specific implementation process for the UE1, and details are not described herein again.

It should be noted that S307 and S308 need to be performed before S309.

S309. Send data on the transmission time-frequency resources.

In this embodiment, after determining the transmission time-frequency resources periodically scheduled to the two UEs, the base station sends data to the two UEs on the determined transmission time-frequency resources, that is, the base station sends data to the two UEs on a same transmission time-frequency resource each time. For example, the base station sends same data to the UE1 and the UE2 on a same transmission time-frequency resource each time, or the base station sends data of a same bearer to the UE1 and the UE2 on the determined transmission time-frequency resources each time, or the base station sends data of a same service to the UE1 and the UE2 on the determined transmission time-frequency resources each time. Correspondingly, after determining the transmission time-frequency resources that are periodically scheduled to the two UEs by the base station, the UEs receive, on the determined transmission time-frequency resources, data sent by the base station, that is, the two UEs receive, on a same transmission time-frequency resource each time, data sent by the base station. For example, the UE1 and the UE2 receive, on a same transmission time-frequency resource each time, same data sent by the base station, or the UE1 and the UE2 receive, on a same transmission time-frequency resource each time, data sent on a same bearer by the base station, or the UE1 and the UE2 receive, on a same transmission time-frequency resource each time, data, sent by the base station, of a same service.

It should be noted that the UE1 and the UE2 may receive all data that is sent by the base station on the transmission time-frequency resource, or may receive some of data that is sent by the base station on the transmission time-frequency resource.

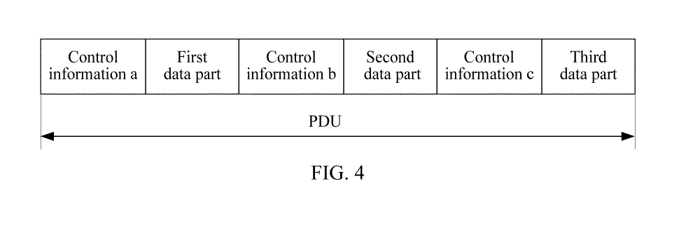

Optionally, the data that is sent to the two UEs by the base station on the transmission time-frequency resource may include control information and first data, the first data is data that needs to be transmitted, the control information includes identification information of at least one of the UEs and length information of the first data, and the control information is used to instruct the at least one UE to acquire the first data according to the data length information. Correspondingly, the UE1 may receive the data that is sent by the base station on the transmission time-frequency resource, where the data includes control information and first data, the first data is data that needs to be transmitted, the control information includes identification information of the UE1 and length information of the first data, and the control information is used to instruct the UE1 to acquire the first data according to the data length information, and the UE1 may acquire, according to the control information, the first data that corresponds to the data length information. The UE2 may receive the data that is sent by the base station on the transmission time-frequency resource, where the data includes control information and first data, the first data is data that needs to be transmitted, the control information includes identification information of the UE2 and length information of the first data, and the control information is used to instruct the UE2 to acquire the first data according to the data length information, and the UE2 may acquire, according to the control information, the first data that corresponds to the data length information. For example, FIG. 4 is a schematic diagram of data in the embodiment of the method for semi-persistent shared resource scheduling shown in FIG. 3. As shown in FIG. 4, in a protocol data unit (Protocol Data Unit, PDU for short) during one time of scheduling and transmission performed by the base station, same data content may be allocated to different UEs, and the PDU may include control indication information about data receiving, for example, information such as identification information of UE that receives data and length information of data to be received. Control information a may indicate that the UE1 and the UE2 need to receive a first data part, control information b may indicate that the UE1 needs to receive a second data part, and control information c may indicate that the UE2 needs to receive a third data part. UE that receives the PDU receives data in the PDU according to the control indication information.

In the method for semi-persistent shared resource scheduling provided in Embodiment 3 of the present invention, a base station determines that M UEs need to receive same data, or use a same bearer, or use a same service, and determines to periodically schedule a transmission time-frequency resource for the same data, or for data transmission on the same bearer, or for the same service; the base station sends, to the M UEs, a configuration enabling message for semi-persistent shared resource scheduling that includes configuration information for semi-persistent shared resource scheduling and configuration activation instruction information for semi-persistent shared resource scheduling; the M UEs acquire and activate, according to the configuration information for semi-persistent shared resource scheduling and the configuration activation instruction information for semi-persistent shared resource scheduling, the configuration information for semi-persistent shared resource scheduling; the base station determines, according to information indicating transmission frequency-domain resources that are scheduled to the M UEs, and times at which the configuration activation instruction information for semi-persistent shared resource scheduling is sent to the M UEs, transmission time-frequency resources periodically scheduled to the M UEs; each UE determines, according to information indicating a transmission frequency-domain resource that is scheduled to the UE by the base station, and a time at which the UE receives the configuration activation instruction information for semi-persistent shared resource scheduling, the transmission time-frequency resource periodically scheduled to the UE by the base station; and the base station sends data to the M UEs on a same transmission time-frequency resource each time. In this way, wireless communication network resource overheads can be reduced.

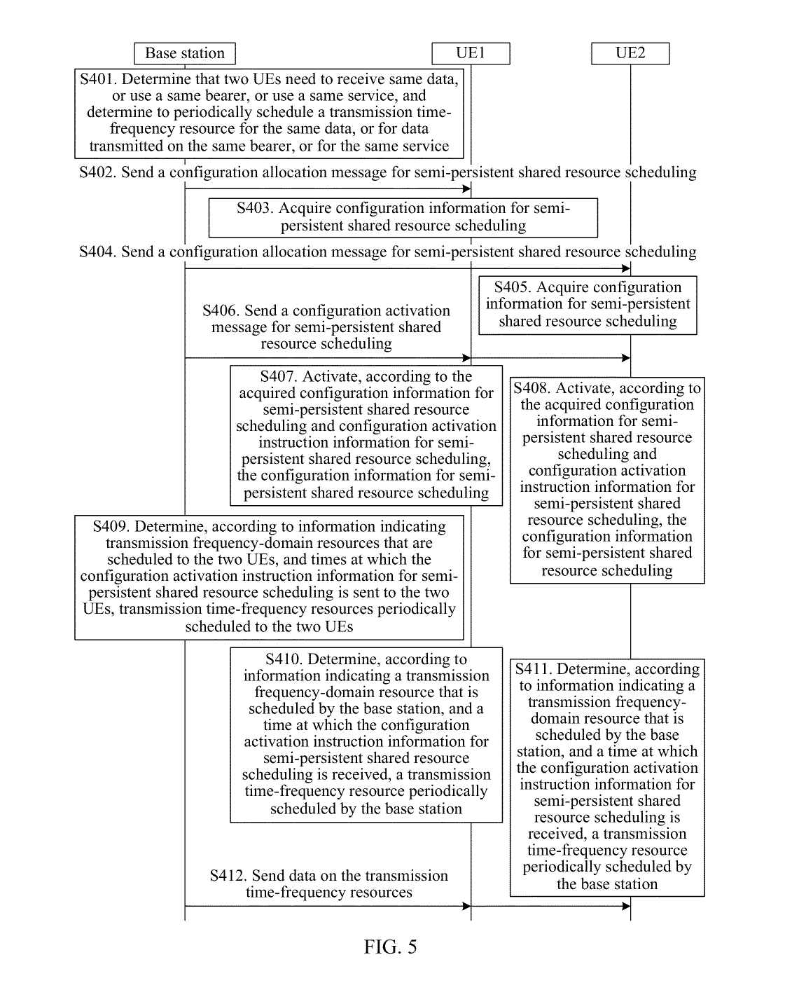

FIG. 5 is a flowchart of Embodiment 4 of a method for semi-persistent shared resource scheduling according to the present invention. As shown in FIG. 5, the method in this embodiment may include:

S401. Determine that two UEs need to receive same data, or use a same bearer, or use a same service, and determine to periodically schedule a transmission time-frequency resource for the same data, or for data transmission on the same bearer, or for the same service.

In this embodiment, a specific implementation process of S401 is similar to the specific implementation process of S301 in the method embodiment shown in FIG. 3, for details, refer to a related description in the foregoing embodiment, and details are not described herein again.

S402. Send a configuration allocation message for semi-persistent shared resource scheduling.

S403. Acquire configuration information for semi-persistent shared resource scheduling.

S404. Send a configuration allocation message for semi-persistent shared resource scheduling.

S405. Acquire configuration information for semi-persistent shared resource scheduling.

In this embodiment, a base station separately sends, to two UEs, a configuration allocation message for semi-persistent shared resource scheduling, where the configuration allocation message for semi-persistent shared resource scheduling includes the configuration information for semi-persistent shared resource scheduling. That is, the base station sends, to the UE1, a configuration allocation message for semi-persistent shared resource scheduling for the UE1, where the configuration allocation message for semi-persistent shared resource scheduling for the UE1 includes configuration information for semi-persistent shared resource scheduling for the UE1, and the UE1 acquires the configuration information for semi-persistent shared resource scheduling for the UE1. The base station sends, to the UE2, a configuration allocation message for semi-persistent shared resource scheduling for the UE2, where the configuration allocation message for semi-persistent shared resource scheduling for the UE2 includes configuration information for semi-persistent shared resource scheduling for the UE2, and the UE2 acquires the configuration information for semi-persistent shared resource scheduling for the UE2.

Optionally, the configuration allocation message for semi-persistent shared resource scheduling may be a radio resource control (Radio Resource Control, RRC for short) connection reconfiguration message.

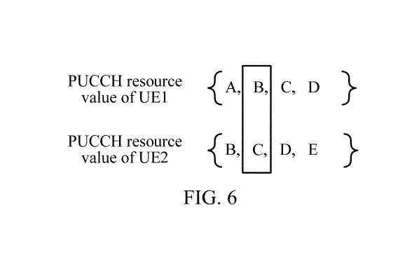

Optionally, the configuration information for semi-persistent shared resource scheduling for the UE1 includes at least one of the following: a shared scheduling C-RNTI of the UE1, a scheduling interval at which the base station schedules a transmission time-frequency resource for the UE1, a quantity of data transmission processes, and a set of shared scheduling feedback channel time-frequency resource information of the UE1. The configuration information for semi-persistent shared resource scheduling for the UE2 includes at least one of the following: shared scheduling C-RNTI of the UE2, a scheduling interval at which the base station schedules a transmission time-frequency resource for the UE2, a quantity of data transmission processes, and a set of shared scheduling feedback channel time-frequency resource information of the UE2. In this embodiment, the shared scheduling C-RNTIs of the UE1 and the UE2 may be the same, and the scheduling interval at which the base station schedules a transmission time-frequency resource for the UE1 is the same as the scheduling interval at which the base station schedules a transmission time-frequency resource for the UE2, but the set of shared scheduling feedback channel time-frequency resource information of the UE1 is different from that of the UE2. FIG. 6 is a schematic diagram of a set of shared scheduling feedback channel time-frequency resource information in the embodiment of the method for semi-persistent shared resource scheduling shown in FIG. 5. As shown in FIG. 6, A, B, C, D, and E indicate different shared scheduling feedback channel time-frequency resource information, and may also be referred to as PUCCH resource values, and in this case, PUCCH resource values of the UE1 may include A, B, C, and D, and PUCCH resource values of the UE2 may include B, C, D, and E, where different data is configured for PUCCH resource values, which belong to a same index, of different UEs. For example, in a block part corresponding to a same index, B is configured as a PUCCH resource value of the UE1, and C is configured as a PUCCH resource value of the UE2. In this way, even if the base station subsequently sends a same configuration activation message for semi-persistent shared resource scheduling to the UE1 and the UE2, shared scheduling feedback channel time-frequency resources that the base station indicates to the UE1 and the UE2 are different.

Optionally, the configuration information for semi-persistent shared resource scheduling further includes shared scheduling reference signal configuration information.

Optionally, the base station may send the shared scheduling reference signal configuration information to the two UEs by means of system broadcast. Correspondingly, the UE1 and the UE2 may receive the shared scheduling reference signal configuration information that is sent by the base station by means of system broadcast.

S406. Send a configuration activation message for semi-persistent shared resource scheduling.

The base station may send, to each of the two UEs, a configuration activation message for semi-persistent shared resource scheduling. In this embodiment, the base station may send, to the two UEs, a same configuration activation message for semi-persistent shared resource scheduling, so that the two UEs simultaneously activate the configuration information for semi-persistent shared resource scheduling. That is, the base station simultaneously sends a same configuration activation message for semi-persistent shared resource scheduling to the UE1 and the UE2, so that the UE1 and the UE2 simultaneously activate respective configuration information for semi-persistent shared resource scheduling.

Optionally, the base station may determine, according to service establishment statuses and/or history resource allocation statuses of the UE1 and the UE2, to send the configuration activation message for semi-persistent shared resource scheduling to the UE1 and the UE2.

Optionally, that the base station may simultaneously send a same configuration activation message for semi-persistent shared resource scheduling to the two UEs includes: the base station sends a same configuration activation message for semi-persistent shared resource scheduling to each UE that is scrambled by using a first shared scheduling C-RNTI, where a shared scheduling C-RNTI of each UE is the first shared scheduling C-RNTI. In this embodiment, a shared scheduling C-RNTI of the UE1 and a shared scheduling C-RNTI of the UE2 are the same, and may also be referred to as the first shared scheduling C-RNTI. The base station sends the same configuration activation message for semi-persistent shared resource scheduling to the UE1 and the UE2, the configuration activation message for semi-persistent shared resource scheduling sent to the UE1 by the base station is scrambled by using the shared scheduling C-RNTI of the UE1, and the configuration activation message for semi-persistent shared resource scheduling sent to the UE2 by the base station is scrambled by using the shared scheduling C-RNTI of the UE2; therefore, the configuration activation message for semi-persistent shared resource scheduling sent to the UE1 and the UE2 by the base station is scrambled by using the first shared scheduling C-RNTI. Correspondingly, after the UE1 and the UE2 receive the configuration allocation message for semi-persistent shared resource scheduling sent by the base station, and acquire the configuration information for semi-persistent shared resource scheduling, the UE1 and the UE2 may listen for the configuration activation message for semi-persistent shared resource scheduling, where a listening range may be a common search space, or may be a shared search space of the UE1 and the UE2; then, the UE1 may receive the configuration activation message for semi-persistent shared resource scheduling that is sent by the base station and that is scrambled by using the first shared scheduling C-RNTI, and the UE2 may also receive the configuration activation message for semi-persistent shared resource scheduling that is sent by the base station and that is scrambled by using the first shared scheduling C-RNTI.

Optionally, configuration activation instruction information for semi-persistent shared resource scheduling that is sent to each UE by the base station includes at least one of the following: an activation instruction for instructing the UE to activate the semi-persistent shared scheduling configuration information, information indicating a transmission frequency-domain resource that is scheduled to the UE by the base station, and information indicating a shared scheduling feedback channel time-frequency resource of the UE. That is, configuration activation instruction information for semi-persistent shared resource scheduling that is sent to the UE1 and the UE2 by the base station includes at least one of the following: an activation instruction for instructing the UE1 and the UE2 to activate the semi-persistent shared scheduling configuration information, information indicating transmission frequency-domain resources that are scheduled to the UE1 and the UE2 by the base station, and information indicating shared scheduling feedback channel time-frequency resources of the UE1 and the UE2. For example, if information that indicates shared scheduling feedback channel time-frequency resources and that is sent to the UE1 and the UE2 by the base station is “2”, as shown in FIG. 6, the UE1 determines, according to “2”, that a PUCCH resource value is B, and the UE2 determines, according to “2”, that a PUCCH resource value is C.

S407. Activate, according to the acquired configuration information for semi-persistent shared resource scheduling and configuration activation instruction information for semi-persistent shared resource scheduling, the configuration information for semi-persistent shared resource scheduling.

S408. Activate, according to the acquired configuration information for semi-persistent shared resource scheduling and configuration activation instruction information for semi-persistent shared resource scheduling, the configuration information for semi-persistent shared resource scheduling.

In this embodiment, the UE1 and the UE2 activate, according to the acquired configuration information for semi-persistent shared resource scheduling and configuration activation instruction information for semi-persistent shared resource scheduling, the configuration information for semi-persistent shared resource scheduling. Optionally, the UE1 and the UE2 receive the configuration activation instruction information for semi-persistent shared resource scheduling sent by the base station, and may simultaneously activate the configuration information for semi-persistent shared resource scheduling, that is, S407 and S408 are simultaneously performed.

S409. Determine, according to information indicating transmission frequency-domain resources that are scheduled to the two UEs, and times at which the configuration activation instruction information for semi-persistent shared resource scheduling is sent to the two UEs, transmission time-frequency resources periodically scheduled to the two UEs.

S410. Determine, according to information indicating a transmission frequency-domain resource that is scheduled by the base station, and a time at which the configuration activation instruction information for semi-persistent shared resource scheduling is received, a transmission time-frequency resource periodically scheduled by the base station.

S411. Determine, according to information indicating a transmission frequency-domain resource that is scheduled by the base station, and a time at which the configuration activation instruction information for semi-persistent shared resource scheduling is received, a transmission time-frequency resource periodically scheduled by the base station.

S412. Send data on the transmission time-frequency resources.

In this embodiment, a specific implementation process of S409 to S412 is similar to the specific implementation process of S306 to S309 in Method Embodiment 3 shown in FIG. 3, for details, refer to a related description in the foregoing embodiment, and details are not described herein again.

In the method for semi-persistent shared resource scheduling provided in Embodiment 4 of the present invention, a base station determines that M UEs need to receive same data, or use a same bearer, or use a same service, and determines to periodically schedule a transmission time-frequency resource for the same data, or for data transmission on the same bearer, or for the same service; the base station separately sends a configuration allocation message for semi-persistent shared resource scheduling to the M UEs; the M UEs acquire configuration information for semi-persistent shared resource scheduling; the base station sends a same configuration activation message for semi-persistent shared resource scheduling to the M UEs; the M UEs activate, according to the acquired configuration information for semi-persistent shared resource scheduling and configuration activation instruction information for semi-persistent shared resource scheduling, the configuration information for semi-persistent shared resource scheduling; the base station determines, according to information indicating transmission frequency-domain resources that are scheduled to the M UEs, and times at which the configuration activation instruction information for semi-persistent shared resource scheduling is sent to the M UEs, transmission time-frequency resources periodically scheduled to the M UEs; each UE determines, according to information indicating a transmission frequency-domain resource that is scheduled to the UE by the base station, and a time at which the UE receives the configuration activation instruction information for semi-persistent shared resource scheduling, a transmission time-frequency resource periodically scheduled to the UE by the base station; and the base station sends data to the M UEs on a same transmission time-frequency resource each time. In this way, wireless communication network resource overheads can be reduced.

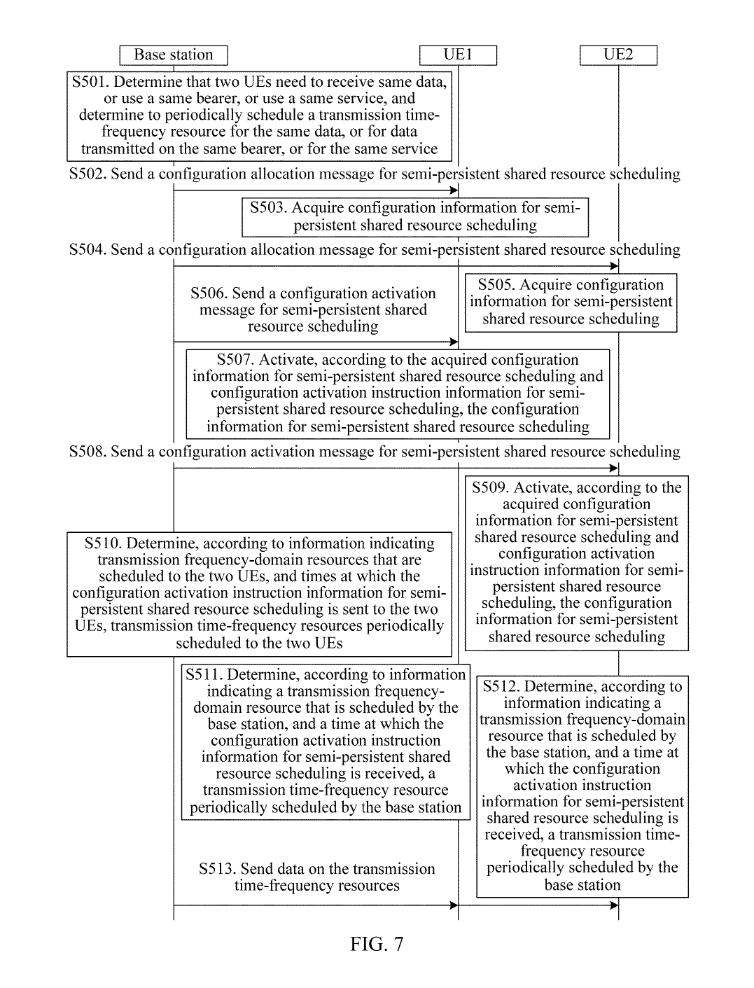

FIG. 7 is a flowchart of Embodiment 5 of a method for semi-persistent shared resource scheduling according to the present invention. As shown in FIG. 7, the method in this embodiment may include:

S501. Determine that two UEs need to receive same data, or use a same bearer, or use a same service, and determine to periodically schedule a transmission time-frequency resource for the same data, or for data transmission on the same bearer, or for the same service.

S502. Send a configuration allocation message for semi-persistent shared resource scheduling.

S503. Acquire configuration information for semi-persistent shared resource scheduling.

S504. Send a configuration allocation message for semi-persistent shared resource scheduling.

S505. Acquire configuration information for semi-persistent shared resource scheduling.

In this embodiment, a specific implementation process of S501 to S505 is similar to the specific implementation process of S401 to S405 in the method embodiment shown in FIG. 4, for details, refer to a related description in the foregoing embodiment, and details are not described herein again. It should be noted that in this embodiment, a shared scheduling C-RNTI of UE1 in the configuration allocation message for semi-persistent shared resource scheduling that is sent to the UE1 by the base station is different from a shared scheduling C-RNTI of the UE2 in the configuration allocation message for semi-persistent shared resource scheduling that is sent to the UE2 by the base station.

S506. Send a configuration activation message for semi-persistent shared resource scheduling.

S507. Activate, according to the acquired configuration information for semi-persistent shared resource scheduling and configuration activation instruction information for semi-persistent shared resource scheduling, the configuration information for semi-persistent shared resource scheduling.

S508. Send a configuration activation message for semi-persistent shared resource scheduling.

S509. Activate, according to the acquired configuration information for semi-persistent shared resource scheduling and configuration activation instruction information for semi-persistent shared resource scheduling, the configuration information for semi-persistent shared resource scheduling.

The base station may send a configuration activation message for semi-persistent shared resource scheduling to each of the two UEs. In this embodiment, the base station may send configuration activation messages for semi-persistent shared resource scheduling to the two UEs respectively, so that each UE of the two UEs separately activates the configuration information for semi-persistent shared resource scheduling. That is, the base station sends, to the UE1, a configuration activation message for semi-persistent shared resource scheduling that is scrambled by using the shared scheduling C-RNTI of the UE1, and the base station sends, to the UE2, a configuration activation message for semi-persistent shared resource scheduling that is scrambled by using the shared scheduling C-RNTI of the UE2, where the shared scheduling C-RNTI of the UE1 and the shared scheduling C-RNTI of the UE2 are different C-RNTIs. Correspondingly, the UE1 listens on a specific search space of the UE1 to receive the configuration activation message for semi-persistent shared resource scheduling that is sent by the base station and that is scrambled by using the shared scheduling C-RNTI of the UE1, and the UE2 listens on a specific search space of the UE2 to receive the configuration activation message for semi-persistent shared resource scheduling that is sent by the base station and that is scrambled by using the shared scheduling C-RNTI of the UE2.

In this embodiment, the UE1 and the UE2 activate, according to the acquired configuration information for semi-persistent shared resource scheduling and configuration activation instruction information for semi-persistent shared resource scheduling, the configuration information for semi-persistent shared resource scheduling. Optionally, the UE1 receives the configuration activation instruction information for semi-persistent shared resource scheduling sent by the base station, and activates the configuration information for semi-persistent shared resource scheduling; and the UE2 receives the configuration activation instruction information for semi-persistent shared resource scheduling sent by the base station, and activates the configuration information for semi-persistent shared resource scheduling.

It should be noted that S506 and S508 may be simultaneously performed.

S510. Determine, according to information indicating transmission frequency-domain resources that are scheduled to the two UEs, and times at which the configuration activation instruction information for semi-persistent shared resource scheduling is sent to the two UEs, transmission time-frequency resources periodically scheduled to the two UEs.

S511. Determine, according to information indicating a transmission frequency-domain resource that is scheduled by the base station, and a time at which the configuration activation instruction information for semi-persistent shared resource scheduling is received, a transmission time-frequency resource periodically scheduled by the base station.

S512. Determine, according to information indicating a transmission frequency-domain resource that is scheduled by the base station, and a time at which the configuration activation instruction information for semi-persistent shared resource scheduling is received, a transmission time-frequency resource periodically scheduled by the base station.

S513. Send data on the transmission time-frequency resources.

In this embodiment, a specific implementation process of S510 to S513 is similar to the specific implementation process of S306 to S309 in Method Embodiment 3 shown in FIG. 3, for details, refer to a related record in the foregoing embodiment, and details are not described herein again.

In the method for semi-persistent shared resource scheduling provided in Embodiment 5 of the present invention, a base station determines that M UEs need to receive same data, or use a same bearer, or use a same service, and determines to periodically schedule a transmission time-frequency resource for the same data, or for data transmission on the same bearer, or for the same service; the base station separately sends a configuration allocation message for semi-persistent shared resource scheduling to the M UEs; the M UEs acquire configuration information for semi-persistent shared resource scheduling; the base station sends, to the M UEs, different configuration activation messages for semi-persistent shared resource scheduling; the M UEs separately activate, according to the acquired configuration information for semi-persistent shared resource scheduling and configuration activation instruction information for semi-persistent shared resource scheduling, the configuration information for semi-persistent shared resource scheduling; the base station determines, according to information indicating transmission frequency-domain resources that are scheduled to the M UEs, and times at which the configuration activation instruction information for semi-persistent shared resource scheduling is sent to the M UEs, transmission time-frequency resources periodically scheduled to the M UEs; each UE determines, according to information indicating a transmission frequency-domain resource that is scheduled to the UE by the base station, and a time at which the UE receives the configuration activation instruction information for semi-persistent shared resource scheduling, a transmission time-frequency resource periodically scheduled to the UE by the base station; and the base station sends data to the M UEs on a same transmission time-frequency resource each time. In this way, wireless communication network resource overheads can be reduced.

Further, based on the foregoing embodiment of the method for semi-persistent shared resource scheduling in the present invention, the method may further include: The UE1 feeds back, on a PUCCH feedback channel specified in the configuration activation message for semi-persistent shared resource scheduling, a receiving status such as acknowledgement (Acknowledgement, ACK for short) or negative acknowledgement (Nack Acknowledgement, NACK for short) according to a data decoding result, and the UE2 may also feed back, on a PUCCH feedback channel specified in the configuration activation message for semi-persistent shared resource scheduling, a receiving status such as ACK or NACK according to a data decoding result. When the base station considers that the base station no longer needs to periodically schedule data to the UE1 and the UE2, the base station may determine to deactivate the configuration information for semi-persistent shared resource scheduling for the UE1 and the UE2. For example, the UE1 has a higher requirement in selecting a resource frequency, and has relatively desirable channel quality on a particular frequency band; therefore, UE1-specific scheduling is used, which helps to improve scheduling efficiency. In this case, the base station may deactivate the configuration information for semi-persistent shared resource scheduling for the UE1. For another example, channel quality of the UE1 and the UE2 on a resource allocated by means of semi-persistent shared resource scheduling is greatly different, and efficiency is low if semi-persistent scheduling continues to be performed on the resource, and in this case, the base station may consider deactivating the configuration information for semi-persistent shared resource scheduling for the UE1 and the UE2, and then, the base station may send a configuration deactivation message for semi-persistent shared resource scheduling to the UE1 and the UE2. Specifically, the configuration deactivation message for semi-persistent shared resource scheduling sent to the UE1 may be scrambled by using a shared scheduling C-RNTI that is configured for the UE1, and the configuration deactivation message for semi-persistent shared resource scheduling sent to the UE2 may be scrambled by using a shared scheduling C-RNTI that is configured for the UE2. After receiving the configuration deactivation message for semi-persistent shared resource scheduling, the UE1 deactivates the configuration information for semi-persistent shared resource scheduling. After receiving the configuration deactivation message for semi-persistent shared resource scheduling, the UE2 deactivates the configuration information for semi-persistent shared resource scheduling. When the base station considers that the configuration information for semi-persistent shared resource scheduling no longer needs to be enabled for the UE1, the base station determines to release the configuration information for semi-persistent shared resource scheduling, and in this case, the base station sends a configuration release message for semi-persistent shared resource scheduling, and after receiving the configuration release message for semi-persistent shared resource scheduling, the UE1 releases the configuration information for semi-persistent shared resource scheduling.

FIG. 8 is a schematic structural diagram of Embodiment 1 of a base station according to the present invention. As shown in FIG. 8, the base station in this embodiment may include: a sending unit 11 and a processing unit 12. The sending unit 11 is configured to send a configuration enabling message for semi-persistent shared resource scheduling to M user equipments UEs, where M is an integer greater than or equal to two; and the processing unit 12 is configured to periodically schedule transmission time-frequency resources for the M UEs according to the configuration enabling message for semi-persistent shared resource scheduling, to send data to the M UEs, where the transmission time-frequency resources that the base station schedules to the M UEs each time are a same transmission time-frequency resource.

The base station in this embodiment may be configured to execute the technical solutions in the foregoing method embodiments of the present invention, and has a similar implementation principle and technical effect; for details, refer to a related description in the foregoing embodiments, and details are not described herein again.

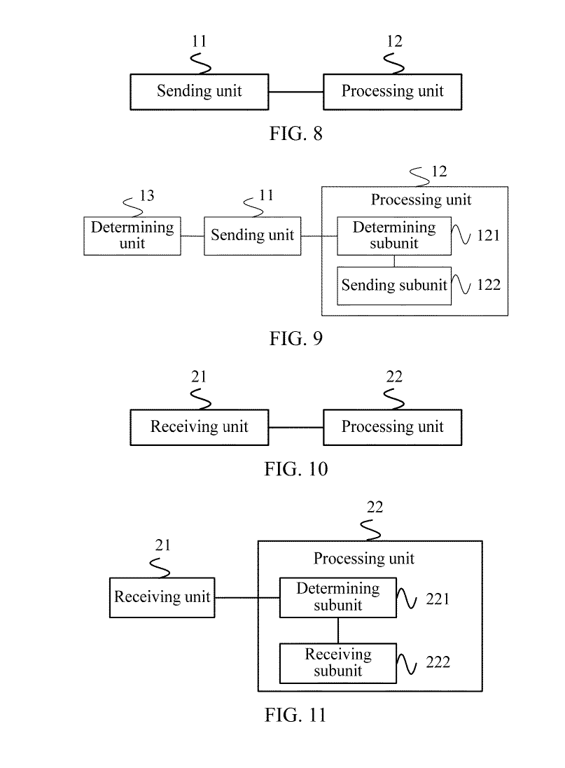

FIG. 9 is a schematic structural diagram of Embodiment 2 of a base station according to the present invention. As shown in FIG. 9, based on the structure of the base station shown in FIG. 8, the base station in this embodiment may further include: a determining unit 13. The determining unit 13 is configured to: before the sending unit 11 sends the configuration enabling message for semi-persistent shared resource scheduling to the M user equipments UEs, determine that the M UEs need to receive same data, or use a same bearer, or use a same service, and determine to periodically schedule a transmission time-frequency resource for the same data, or for data transmission on the same bearer, or for the same service.

Optionally, the sending unit 11 is specifically configured to separately send, to the M UEs, a configuration enabling message for semi-persistent shared resource scheduling that includes configuration information for semi-persistent shared resource scheduling, so that the M UEs acquire and activate the configuration information for semi-persistent shared resource scheduling.

Optionally, the sending unit 11 is specifically configured to separately send, to the M UEs, a configuration enabling message for semi-persistent shared resource scheduling that includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling, so that the M UEs acquire and activate the configuration information for semi-persistent shared resource scheduling.

Optionally, the sending unit 11 is specifically configured to separately send a configuration allocation message for semi-persistent shared resource scheduling to the M UEs, where the configuration allocation message for semi-persistent shared resource scheduling includes configuration information for semi-persistent shared resource scheduling; and send a configuration activation message for semi-persistent shared resource scheduling to each of the M UEs, where the configuration activation message for semi-persistent shared resource scheduling includes configuration activation instruction information for semi-persistent shared resource scheduling, and the configuration activation instruction information for semi-persistent shared resource scheduling is used to instruct to activate the configuration information for semi-persistent shared resource scheduling.

Optionally, the sending unit 11 is specifically configured to send, to the M UEs respectively, configuration activation messages for semi-persistent shared resource scheduling, so that each UE of the M UEs separately activates the configuration information for semi-persistent shared resource scheduling.

Optionally, the sending unit 11 is specifically configured to send, to each UE, a configuration activation message for semi-persistent shared resource scheduling that is scrambled by using a shared scheduling cell radio network temporary identifier C-RNTI of each UE, where the shared scheduling C-RNTIs of the UEs are different shared scheduling C-RNTIs.

Optionally, the sending unit 11 is specifically configured to send, to the M UEs, a same configuration activation message for semi-persistent shared resource scheduling, so that the M UEs simultaneously activate the configuration information for semi-persistent shared resource scheduling.

Optionally, the sending unit 11 is specifically configured to send, to each UE, a same configuration activation message for semi-persistent shared resource scheduling that is scrambled by using the first shared scheduling C-RNTI, where a shared scheduling C-RNTI of each UE is the first shared scheduling C-RNTI.

Optionally, the configuration activation instruction information for semi-persistent shared resource scheduling that is sent to each UE by the sending unit 11 includes at least one of the following: an activation instruction for instructing the UE to activate the semi-persistent shared scheduling configuration information, information indicating a transmission frequency-domain resource that is scheduled to each UE by the base station, and information indicating a shared scheduling feedback channel time-frequency resource of each UE.

Optionally, the configuration information for semi-persistent shared resource scheduling that is sent to each UE by the sending unit 11 includes at least one of the following: the shared scheduling C-RNTI of each UE, a scheduling interval at which the base station schedules a transmission time-frequency resource for each UE, a quantity of data transmission processes, and a set of shared scheduling feedback channel time-frequency resource information of each UE.

Optionally, the configuration information for semi-persistent shared resource scheduling further includes shared scheduling reference signal configuration information.

Optionally, the sending unit 11 is further configured to send the shared scheduling reference signal configuration information to the M UEs by means of system broadcast.

Further, the processing unit 12 may further include: a determining subunit 121 and a sending subunit 122, where the determining subunit 121 is configured to determine, according to the information indicating the transmission frequency-domain resources that are scheduled to the M UEs, and times at which the base station sends the configuration activation instruction information for semi-persistent shared resource scheduling to the M UEs, the transmission time-frequency resources periodically scheduled to the M UEs; and the sending subunit 122 is configured to send, on the transmission time-frequency resources, the data to the M UEs.

Optionally, the data includes control information and first data, the first data is data that needs to be transmitted, the control information includes identification information of at least one of the UEs and length information of the first data, and the control information is used to instruct the at least one UE to acquire the first data according to the data length information.

The base station in this embodiment may be used in the technical solutions in the foregoing method embodiments of the present invention, and has a similar implementation principle and technical effect; for details, refer to a related description in the foregoing method embodiments, and details are not described herein again.

In hardware implementation, the sending unit 11 may be a transmitter or a transceiver, and the sending subunit 122 in the processing unit 12 may be a transmitter or a transceiver. The determining unit 13 and the determining subunit 121 in the processing unit 12 may be built in or independent from a processor of the base station in a form of hardware, or may be stored in a memory of the base station in a form of software, so that the processor conveniently invokes and executes operations that correspond to the foregoing units. The processor may be a central processing unit (Central Processing Unit, CPU for short), a microprocessor, a single-chip microcomputer, or the like.

FIG. 10 is a schematic structural diagram of Embodiment 1 of UE according to the present invention. As shown in FIG. 10, the UE in this embodiment may include: a receiving unit 21 and a processing unit 22, where the receiving unit 21 is configured to receive a configuration enabling message for semi-persistent shared resource scheduling sent by a base station; and the processing unit 22 is configured to periodically receive, according to the configuration enabling message for semi-persistent shared resource scheduling, data sent on a transmission time-frequency resource that is scheduled to the UE by the base station, where the transmission time-frequency resource scheduled to the UE by the base station each time and transmission time-frequency resources scheduled by the base station to M UEs including the UE are a same transmission time-frequency resource, and M is an integer greater than or equal to two.

The UE in this embodiment may be configured to execute the technical solutions in the foregoing method embodiments of the present invention, and has a similar implementation principle and technical effect; for details, refer to a related record in the foregoing embodiments, and details are not described herein again.

FIG. 11 is a schematic structural diagram of Embodiment 2 of UE according to the present invention. As shown in FIG. 11, based on the structure of the UE shown in FIG. 10, in the UE in this embodiment, optionally, the receiving unit 21 is specifically configured to receive a configuration enabling message for semi-persistent shared resource scheduling that is sent by the base station and that includes configuration information for semi-persistent shared resource scheduling; and acquire and activate, according to the configuration enabling message for semi-persistent shared resource scheduling, the configuration information for semi-persistent shared resource scheduling.

Optionally, the receiving unit 21 is specifically configured to receive a configuration enabling message for semi-persistent shared resource scheduling that is sent by the base station and that includes configuration information for semi-persistent shared resource scheduling and configuration activation instruction information for semi-persistent shared resource scheduling, where the configuration activation instruction information for semi-persistent shared resource scheduling is used to instruct to activate the configuration information for semi-persistent shared resource scheduling; and acquire and activate, according to the configuration information for semi-persistent shared resource scheduling and the configuration activation instruction information for semi-persistent shared resource scheduling, the configuration information for semi-persistent shared resource scheduling.

Optionally, the receiving unit 21 is specifically configured to receive a configuration allocation message for semi-persistent shared resource scheduling sent by the base station, where the configuration allocation message for semi-persistent shared resource scheduling includes the configuration information for semi-persistent shared resource scheduling; acquire the configuration information for semi-persistent shared resource scheduling; receive a configuration activation message for semi-persistent shared resource scheduling sent by the base station; and activate, according to the acquired configuration information for semi-persistent shared resource scheduling and the configuration activation instruction information for semi-persistent shared resource scheduling, the configuration information for semi-persistent shared resource scheduling.

Optionally, the receiving unit 21 is specifically configured to receive a configuration activation message for semi-persistent shared resource scheduling that is sent by the base station and that is scrambled by using a shared scheduling cell radio network temporary identifier C-RNTI of the UE.

Optionally, the configuration activation instruction information for semi-persistent shared resource scheduling includes at least one of the following: an activation instruction for instructing the UE to activate the semi-persistent shared scheduling configuration information, information indicating a transmission frequency-domain resource that is scheduled to the UE by the base station, and information indicating a shared scheduling feedback channel time-frequency resource of the UE.

Optionally, the configuration information for semi-persistent shared resource scheduling includes at least one of the following: the shared scheduling C-RNTI of the UE, a scheduling interval at which the base station schedules a transmission time-frequency resource for the UE, a quantity of data transmission processes, and a set of shared scheduling feedback channel time-frequency resource information of the UE.

Optionally, the configuration information for semi-persistent shared resource scheduling further includes shared scheduling reference signal configuration information.

Optionally, the receiving unit 21 is further configured to receive shared scheduling reference signal configuration information that is sent by the base station by means of system broadcast.

Further, the processing unit 22 may further include: a determining subunit 221 and a receiving subunit 222, where the determining subunit 221 is configured to determine, according to the information indicating the transmission frequency-domain resource that is scheduled to the UE by the base station, and a time at which the UE receives the configuration activation instruction information for semi-persistent shared resource scheduling, the transmission time-frequency resource periodically scheduled to the UE by the base station; and the receiving subunit 222 is configured to receive, on the transmission time-frequency resource, the data sent by the base station.

Optionally, the data includes control information and first data, the first data is data that needs to be transmitted, the control information includes identification information of the UE and length information of the first data, and the control information is used to instruct the UE to acquire the first data according to the data length information; and the receiving subunit 222 is specifically configured to acquire the first data according to the control information.

The UE in this embodiment may be configured to execute the technical solutions in the foregoing method embodiments of the present invention, and has a similar implementation principle and technical effect; for details, refer to a related record in the foregoing embodiments, and details are not described herein again.

In hardware implementation, the receiving unit 21 may be a transmitter or a transceiver, and the receiving subunit 222 in the processing unit 22 may be a transmitter or a transceiver. The determining subunit 221 in the processing unit 22 may be built in or independent from a processor of the UE in a form of hardware, or may be stored in a memory of the UE in a form of software, so that the processor conveniently invokes and executes operations that correspond to the foregoing units. The processor may be a CPU, a microprocessor, a single-chip microcomputer, or the like.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A method for semi-persistent shared resource scheduling, the method comprising:
sending, by a base station to M user equipments (UEs), a configuration enabling message for semi-persistent shared resource scheduling, wherein M is an integer greater than or equal to two; and
periodically scheduling, by the base station, transmission time-frequency resources for the M UEs according to the configuration enabling message for semi-persistent shared resource scheduling, to send data to the M UEs, wherein the transmission time-frequency resources that the base station schedules to the M UEs each time are a same transmission time-frequency resource.

2. The method according to claim 1, wherein before sending, by a base station to M user equipments (UEs), a configuration enabling message for semi-persistent shared resource scheduling, the method comprises:
determining, by the base station, that the M UEs need to receive same data, or use a same bearer, or use a same service, and determining to periodically schedule a transmission time-frequency resource for the same data, or for data transmission on the same bearer, or for the same service.

3. The method according to claim 1, wherein sending, by a base station to M user equipments (UEs), a configuration enabling message for semi-persistent shared resource scheduling comprises:
separately sending, by the base station to the M UEs, a configuration enabling message for semi-persistent shared resource scheduling that comprises configuration information for semi-persistent shared resource scheduling, so that the M UEs acquire and activate the configuration information for semi-persistent shared resource scheduling.

4. The method according to claim 1, wherein sending, by a base station to M user equipments (UEs), a configuration enabling message for semi-persistent shared resource scheduling comprises:
separately sending, by the base station to the M UEs, a configuration enabling message for semi-persistent shared resource scheduling that comprises configuration information for semi-persistent shared resource scheduling and configuration activation instruction information for semi-persistent shared resource scheduling, wherein the configuration activation instruction information for semi-persistent shared resource scheduling is used to instruct to activate the configuration information for semi-persistent shared resource scheduling, so that the M UEs acquire and activate the configuration information for semi-persistent shared resource scheduling.

5. The method according to claim 1, wherein sending, by a base station to M user equipments (UEs), a configuration enabling message for semi-persistent shared resource scheduling comprises:
separately sending, by the base station to the M UEs, a configuration allocation message for semi-persistent shared resource scheduling, wherein the configuration allocation message for semi-persistent shared resource scheduling comprises the configuration information for semi-persistent shared resource scheduling; and
sending, by the base station to each of the M UEs, a configuration activation message for semi-persistent shared resource scheduling, wherein the configuration activation message for semi-persistent shared resource scheduling comprises configuration activation instruction information for semi-persistent shared resource scheduling, and the configuration activation instruction information for semi-persistent shared resource scheduling is used to instruct to activate the configuration information for semi-persistent shared resource scheduling.

6. The method according to claim 4, wherein the configuration activation instruction information for semi-persistent shared resource scheduling sent to each UE by the base station comprises at least one of the following:
an activation instruction for instructing the UE to activate the semi-persistent shared scheduling configuration information, information indicating a transmission frequency-domain resource that is scheduled to each UE by the base station, and information indicating a shared scheduling feedback channel time-frequency resource of each UE.

7. The method according to claim 6, wherein the configuration information for semi-persistent shared resource scheduling sent to each UE by the base station comprises at least one of the following:
a shared scheduling cell radio network temporary identifier (C-RNTI) of each UE, a scheduling interval at which the base station schedules a transmission time-frequency resource for each UE, a quantity of data transmission processes, and a set of shared scheduling feedback channel time-frequency resource information of each UE.

8. A method for semi-persistent shared resource scheduling, the method comprising:
receiving, by user equipment (UE), a configuration enabling message for semi-persistent shared resource scheduling sent by a base station; and
periodically receiving, by the UE according to the configuration enabling message for semi-persistent shared resource scheduling, data sent on a transmission time-frequency resource that is scheduled to the UE by the base station, wherein the transmission time-frequency resource scheduled to the UE by the base station each time and transmission time-frequency resources scheduled by the base station to M UEs comprising the UE are a same transmission time-frequency resource, and M is an integer greater than or equal to two.

9. The method according to claim 8, wherein receiving, by user equipment (UE), a configuration enabling message for semi-persistent shared resource scheduling sent by a base station comprises:
receiving, by the UE, a configuration enabling message for semi-persistent shared resource scheduling sent by the base station and that comprises configuration information for semi-persistent shared resource scheduling; and
acquiring and activating, by the UE according to the configuration enabling message for semi-persistent shared resource scheduling, the configuration information for semi-persistent shared resource scheduling.

10. The method according to claim 8, wherein receiving, by user equipment (UE), a configuration enabling message for semi-persistent shared resource scheduling sent by a base station comprises:
receiving, by the UE, a configuration enabling message for semi-persistent shared resource scheduling sent by the base station and that comprises configuration information for semi-persistent shared resource scheduling and configuration activation instruction information for semi-persistent shared resource scheduling, wherein the configuration activation instruction information for semi-persistent shared resource scheduling is used to instruct to activate the configuration information for semi-persistent shared resource scheduling; and
acquiring and activating, by the UE according to the configuration information for semi-persistent shared resource scheduling and the configuration activation instruction information for semi-persistent shared resource scheduling, the configuration information for semi-persistent shared resource scheduling.

11. The method according to claim 8, wherein receiving, by user equipment (UE), a configuration enabling message for semi-persistent shared resource scheduling sent by a base station comprises:
receiving, by the UE, a configuration allocation message for semi-persistent shared resource scheduling sent by the base station, wherein the configuration allocation message for semi-persistent shared resource scheduling comprises the configuration information for semi-persistent shared resource scheduling;
acquiring, by the UE, the configuration information for semi-persistent shared resource scheduling;
receiving, by the UE, a configuration activation message for semi-persistent shared resource scheduling sent by the base station; and
activating, by the UE according to the acquired configuration information for semi-persistent shared resource scheduling and the configuration activation instruction information for semi-persistent shared resource scheduling, the configuration information for semi-persistent shared resource scheduling.

12. The method according to claim 10, wherein the configuration activation instruction information for semi-persistent shared resource scheduling comprises at least one of the following:
an activation instruction for instructing the UE to activate the semi-persistent shared scheduling configuration information, information indicating a transmission frequency-domain resource that is scheduled to the UE by the base station, and information indicating a shared scheduling feedback channel time-frequency resource of the UE.

13. A base station, comprising:
a sending unit, configured to send, to M user equipments (UEs), a configuration enabling message for semi-persistent shared resource scheduling, wherein M is an integer greater than or equal to two; and
a processing unit, configured to periodically schedule transmission time-frequency resources for the M UEs according to the configuration enabling message for semi-persistent shared resource scheduling, to send data to the M UEs, wherein the transmission time-frequency resources that the base station schedules to the M UEs each time are a same transmission time-frequency resource.

14. The base station according to claim 13, further comprising a determining unit, configured to:
before the sending unit sends, to the M user equipments (UEs), the configuration enabling message for semi-persistent shared resource scheduling, determine that the M UEs need to receive same data, or use a same bearer, or use a same service, and determine to periodically schedule a transmission time-frequency resource for the same data, or for data transmission on the same bearer, or for the same service.

15. The base station according to claim 13, wherein the sending unit is configured to:
separately send, to the M UEs, a configuration enabling message for semi-persistent shared resource scheduling that comprises configuration information for semi-persistent shared resource scheduling, so that the M UEs acquire and activate the configuration information for semi-persistent shared resource scheduling.

16. The base station according to claim 13, wherein the sending unit is configured to:
separately send, to the M UEs, a configuration enabling message for semi-persistent shared resource scheduling that comprises configuration information for semi-persistent shared resource scheduling and configuration activation instruction information for semi-persistent shared resource scheduling, wherein the configuration activation instruction information for semi-persistent shared resource scheduling is used to instruct to activate the configuration information for semi-persistent shared resource scheduling, so that the M UEs acquire and activate the configuration information for semi-persistent shared resource scheduling.

17. The base station according to claim 13, wherein the sending unit is configured to:
separately send, to the M UEs, a configuration allocation message for semi-persistent shared resource scheduling, wherein the configuration allocation message for semi-persistent shared resource scheduling comprises configuration information for semi-persistent shared resource scheduling; and
send, to each of the M UEs, a configuration activation message for semi-persistent shared resource scheduling, wherein the configuration activation message for semi-persistent shared resource scheduling comprises configuration activation instruction information for semi-persistent shared resource scheduling, and the configuration activation instruction information for semi-persistent shared resource scheduling is used to instruct to activate the configuration information for semi-persistent shared resource scheduling.

18. The base station according to claim 16, wherein the configuration activation instruction information for semi-persistent shared resource scheduling sent to each UE by the sending unit comprises at least one of the following:
an activation instruction for instructing the UE to activate the semi-persistent shared scheduling configuration information, information indicating a transmission frequency-domain resource that is scheduled to each UE by the base station, and information indicating a shared scheduling feedback channel time-frequency resource of each UE.

19. The base station according to claim 18, wherein the configuration information for semi-persistent shared resource scheduling sent to each UE by the sending unit comprises at least one of the following:
a shared scheduling cell radio network temporary identifier (C-RNTI) of each UE, a scheduling interval at which the base station schedules a transmission time-frequency resource for each UE, a quantity of data transmission processes, and a set of shared scheduling feedback channel time-frequency resource information of each UE.

20. User equipment (UE), comprising:
a receiving unit, configured to receive a configuration enabling message for semi-persistent shared resource scheduling sent by a base station; and
a processing unit, configured to periodically receive, according to the configuration enabling message for semi-persistent shared resource scheduling, data sent on a transmission time-frequency resource that is scheduled to the UE by the base station, wherein the transmission time-frequency resource scheduled to the UE by the base station each time and transmission time-frequency resources scheduled by the base station to M UEs comprising the UE are a same transmission time-frequency resource, and M is an integer greater than or equal to two.

21. The UE according to claim 20, wherein the receiving unit is configured to:
receive a configuration enabling message for semi-persistent shared resource scheduling sent by the base station and that comprises configuration information for semi-persistent shared resource scheduling; and
acquire and activate, according to the configuration enabling message for semi-persistent shared resource scheduling, the configuration information for semi-persistent shared resource scheduling.

22. The UE according to claim 20, wherein the receiving unit is configured to:
receive a configuration enabling message for semi-persistent shared resource scheduling sent by the base station and that comprises configuration information for semi-persistent shared resource scheduling and configuration activation instruction information for semi-persistent shared resource scheduling, wherein the configuration activation instruction information for semi-persistent shared resource scheduling is used to instruct to activate the configuration information for semi-persistent shared resource scheduling; and
acquire and activate, according to the configuration information for semi-persistent shared resource scheduling and the configuration activation instruction information for semi-persistent shared resource scheduling, the configuration information for semi-persistent shared resource scheduling.

23. The UE according to claim 20, wherein the receiving unit is configured to:
receive a configuration allocation message for semi-persistent shared resource scheduling sent by the base station, wherein the configuration allocation message for semi-persistent shared resource scheduling comprises the configuration information for semi-persistent shared resource scheduling;
acquire the configuration information for semi-persistent shared resource scheduling;
receive a configuration activation message for semi-persistent shared resource scheduling sent by the base station; and
activate, according to the acquired configuration information for semi-persistent shared resource scheduling and the configuration activation instruction information for semi-persistent shared resource scheduling, the configuration information for semi-persistent shared resource scheduling.

24. The UE according to claim 19, wherein the configuration activation instruction information for semi-persistent shared resource scheduling comprises at least one of the following:
an activation instruction for instructing the UE to activate the semi-persistent shared scheduling configuration information, information indicating a transmission frequency-domain resource that is scheduled to the UE by the base station, and information indicating a shared scheduling feedback channel time-frequency resource of the UE.
